(19) United States
(12) Patent Application Publication
(10) Pub. No.: US 2002/0039544 A1
(43) Pub. Date: Apr. 4, 2002

(54) Efficient aseptic fluid transfer apparatus and consumable therefor

(76) Inventors: Kirk S. Schroeder, Ann Arbor, MI (US); Brad D. Neagle, Ann Arbor, MI (US)

Correspondence Address: John G. Posa, Gifford, Krass, Groh, Suite 400, 280 N. Old Woodward Ave., Birmingham, MI, 48009, US

(21) Appl. No.: 09/949,240

(22) Filed: Sep. 7, 2001

Related U.S. Application Data
(60) Provisional application No. 60/237,536, filed on Oct. 4, 2000.

(51) Int. Cl. B01L 3/02

(52) U.S. Cl. 422/99; 422/100; 73/864; 73/864.34

(57) ABSTRACT

A peristaltic-pump dispenser is mated to a prepackaged and sterilized plastic consumable, enabling the transfer of sterile fluids in a fast, aseptic manner. The transfer of fluid from a source reservoir to a destination reservoir can be accomplished in a single step, bypassing the aspirate-move-dispense steps required of conventional hand-held pipette techniques. The consumable preferably includes an injection-molded plastic piece that contains two tubes; an input spout and an output spout joined by a cross-brace. In order to provide a fluid path the spouts are joined by a flexible piece of pre-sterilized tubing which provides an acceptable interface to the peristaltic pump rollers, allowing for fluid flow. The spouts are constructed of a sterilizeable plastic such as polystyrene. The consumable is pre-sterilized and packaged using EtO, Gamma irradiation, or other suitable techniques. The output spout preferably includes a diameter-reducing nozzle, and the input spout is preferably longer than the output spout to enable bottles to be placed under and removed with relative ease.

### REFERENCE TO RELATED APPLICATION

This application claims priority from provisional patent application Serial No. 60/237,536, filed Oct. 4, 2000, the entire contents of which are incorporated herein by reference.

### FIELD OF THE INVENTION

This invention relates generally to fluid transfer and, in particular, directed to apparatus and methods used to improve the efficiency of sterile fluid transfer.

### BACKGROUND OF THE INVENTION

In the fields of biology and medicine, various qualitative and quantitative methods of analysis are used which require strict control over the amount of fluid transferred from one container to another, and/or the prevention of sample contamination and cross-contamination. For these reasons, pipettes are used extensively in areas where accurate measurement and delivery of fluids are required, particularly the medical and laboratory testing and measurement fields.

Pipettes are available in glass and plastic, in disposable and reusable varieties, and facilitate fluid transfers as well as volumetric measurements. Three volumetric classes are currently in use: ultra-micro pipettes (for transfers of less than 0.1 ml); micropipettes (<1.0 ml); and macropipettes (>1.0 ml). Three functional classes are also recognized, including those calibrated to deliver a specific volume with the last drop remaining in the tip of the instrument (labeled “TD”); those calibrated to contain a specific volume with the last drop being expelled (labeled “TC”); and those which are uncalibrated (and unlabeled) for transfer processes.

Volumetric pipettes are capable of delivering a much more precise amount of liquid than a simple transfer pipette and, as a result, require more precision in creating the stem portion which defines the chamber which retains and delivers the liquid. The stem of a volumetric pipette is usually open at both ends and thus requires a pipette aid, such as a rubber bulb or similar device, to help draw up the liquid into the stem. Once fluid is drawn into the stem, it remains there until the bulb is again squeezed to release some or all, typically into a different container. By carefully manipulating the bulb, a user can generally release the fluid a drop at a time. The size or volume of the drop is usually determined by the size of the opening formed at the tip of the stem. The stem may also include calibrations which allow the user to deliver larger measured amounts of liquid at one time.

Various pipette designs have been developed over the years, with most including a narrow tube or stem into which the liquid is drawn. Early-style pipettes were generally made from glass tubing with a flexible rubber bulb attached at one end. Modern instruments employ disposable tips to avoid contamination of the samples from each other. Advances in plastic forming have also led to the development of entirely disposable plastic transfer pipettes. These are formed as a single piece which includes a stem portion and a built-in bulb for drawing the liquid into the stem. Such devices are generally utilized for transferring liquids which do not have to be precisely measured.

In addition to manually operated devices, numerous semi-automatic and fully automated pipetting aids have been developed. In most all cases, the sample is sucked into the pipette by means of a negative air pressure. Two fundamental approaches are used: air-cushion pipettes (piston-stroke pipettes), and positive-displacement systems. Piston-stroke pipettes have an air cushion which moves between the piston and the sample solution, and which aspirates and dispenses the sample much like an elastic spring. Positive-displacement systems function with virtually no air cushion, since an integrated piston in the pipette tip comes into direct contact with the sample solution. The piston is replaced after every pipetting process.

Methods utilized in the life science industry for transferring sterile or aseptic fluids (e.g. during cell culture) often involve the use of hand-held pipetting wands which mate to a disposable, pre-sterilized polystyrene tube or “pipette.” FIG. 1 depicts such a system. The user manually unwraps a pre-packaged, sterilized pipette 2, press fits the pipette into a hand held pipette wand 4, and lowers the pipette into a reservoir containing the sterile fluid to be transferred 6. By manually pressing a trigger on the wand, a small pump inside the wand is activated which produces a negative pressure inside the plastic pipette and thereby aspirates fluid into the pipette. Once the proper volume is achieved, or prior to the pipette being completely filled, the user release the trigger, lifts the pipette out of the source reservoir and transfers fluid from source reservoir to destination reservoir 8. After reaching the destination reservoir, the user then reverses the action of the pump thereby dispensing the fluid.

To increase throughput, automatic pumps are becoming common in many medical applications. Liquids ranging from test samples to various reagents and wash fluids must be transferred, dispensed or metered, depending on the application. As these devices are designed to use smaller and smaller volumes of fluids, the requirements for very accurate metering pumps have become greater. Fluid transfer is typically accomplished using centrifugal or positive-displacement pumps. Centrifugal pumps transfer energy to a fluid via a spinning impeller, converting the impeller energy to fluid pressure which moves the fluid. Although centrifugal pumps are capable of high flow rates at low pressures, they are typically not utilized for metering due to their inability to maintain very accurate flows under changing inlet and discharge conditions.

In automated apparatus, positive displacement pumps operate by trapping a fixed volume of fluid and moving this fluid via gears, pistons, diaphragms, vanes or other devices. These pumps typically operate at lower speeds, but are less sensitive to changes in discharge and suction conditions, and allow flow regulation by adjusting speed and displacement. Positive displacement metering pumps are normally classified as rotary or reciprocating. Rotary pumps include gear, lobe, vane, and roller (peristaltic) pumps. Reciprocating pumps include diaphragm, piston, and bellows pumps.

In a peristaltic pump, flow is created in a tube by through a rotating roller system that alternately compresses and relaxes a section of the tubing. Generally there are three or four sets of rollers. As the compressed section recovers its shape, suction is created, drawing in fluid, which is then pushed forward by the next advancing roller. For the pump to provide accurate flow, the roller must squeeze the tube down completely to prevent re-circulation, placing high stresses on the tubing. Peristaltic pumps are non-siphoning because one roller is always squeezing the tube closed.

FIG. 2 depicts the action of a peristaltic pump at three separate time points within a pump cycle. As shown, the action of the pump 10 is to turn a set of rollers 12 which contact a flexible tube 14. The rollers essentially pinch off packets of fluid 16 in the tubing, creating positive pressure ahead of the roller and negative pressure behind the roller. This, in-turn provides fluid flow. The advantage of peristaltic pump geometry for aseptic transfer is that the fluid never makes contact with the mechanical components of the pump. Because of this geometry, sterility requirements are therefore confined to the tubing thereby eliminating rigorous cleaning and sterilization of mechanical pump components.

Peristaltic pumps can accurately meter very low flows down to fractions of a milliliter, have a seamless, sterilizable, flow-path in which the pump never contacts the fluid, require no valves, can handle some particulates and are easy to maintain. They are not typically suitable for high pressures and their major disadvantage is the tubing life. Selection of the tubing is a balance between choosing a flexible material with long life and materials with adequate chemical resistance. As tubing wears and looses its flexibility, the accuracy of the pump in metering applications also suffers. Peristaltic pumps are available from a variety of manufacturers, including Barnant, Anko Products, Inc., the Autoclude Division of Victor Pyrate Ltd., Ismatec SA, Pulsafeeder, Inc., SciLog, Inc., and Watson-Marlow Bredel.

In some pipetting apparatus the peristaltic effect is used for fluid transfer. U.S. Pat. No. 4,195,526, for example, teaches a pipetter for drawing fluid into capillary tubes and the like. A capillary tube is forced into an adapter coupled to one end of a vented, flexible tube. A compression wheel rides in a guideway adjacent the tube, and is rolled to continuously vary the point at which the tube is compressed in the manner of a peristaltic pump. Manual rolling of the wheel away from the capillary tube produces sufficient suction in the tube to cause liquid to be drawn into it. The pumping action is reversible in that rolling the wheel back toward the capillary tube will cause fluid to be expelled. Provision is made to prevent undesirable “compression set” as a result of long term static compression of the flexible tube during periods of non-use.

Many automated transfer-type pipetters function by mechanically applying pressure to a bulb or tube. U.S. Pat. No. 5,406,856 discloses a pipetting apparatus having a tube-like tip portion and a deformable portion which is assembled with the tip portion to a unit. With the tip placed in a receptacle, an actuating device and an adjusting device coupled thereto rests against the outside of the deformable portion to press or release the deformable portion, whereby the inner width of the undeformed deformable portion exceeds the inner width of the tip opening and the adjusting device deforms the deformable portion about the whole deformation range of the work volume principally in transverse direction.

In U.S. Pat. No. 5,453,246, a dispensing apparatus includes a tube-feeding portion which holds and feeds a tube made of an elastic material, a tube nozzle portion which supports an end portion of the tube and guides the tube to a liquid container by moving the tube up and down and from side to side, and a tube-pressing and conveying portion between the tube-feeding portion and the tube nozzle portion. The tube-pressing portion draws out the tube from the tube-feeding portion, presses the tube and conveys the tube to the tube nozzle portion. A tube end-discarding portion includes tube-pressing rollers which press the tube and set a length of a tube-pressing portion.

In U.S. Pat. No. 6,033,911, an automated assaying system is disclosed having a multiplicity of lumens oriented and controllable in clusters. The lumens are portrayed in a matrix, wherein each row of the matrix consists of one such cluster that is individually controllable for aspiration and dispensation purposes. Also provided is a wash system capable of flushing the entirety of the system. Commencing from a hydraulic solution source which may contain any acceptable hydraulic solution, including water, sterile saline, solvent, or some other washing solution, a pump feeds a conduit consisting of branch tubing coupled to distribution valves that channel the wash fluid into a plurality of controllable cells. In particular, the distribution valves provide output lines as arterial tubing in equal numbers of six which spread to twelve housings via a valve on each housing. The pump is preferably of the peristaltic type.

Despite these advances, the need remains for improved methods of fluid transfer. Many smaller labs and organizations cannot afford complex, highly automated systems, and existing manual techniques pose numerous limitations. For one, the transfer of a sample from a source reservoir to a destination reservoir is by definition a three-step process, namely, aspirate, move, and dispense. The volume of the transfer is also limited to the pipette size, thereby forcing large volumes to require a multiple aspirate/dispense protocol. The operator must ensure that sterility is not compromised by touching the pipette on any non-sterile surface (e.g. the outside of bottles) during transfer, and individual aspirate and dispense speeds are quite slow, typically limited to less than 5 ml/sec.

Currently in academia and industry, the transfer of aseptic fluids is generally accomplished by ensuring that the fluids only contact pre-sterilized plastic or glassware and is only accessed in an aseptic environment, e.g. a clean room, operatory or biological safety cabinet. Glass sterilization is usually done with an autoclave thereby subjecting the sample to high heat and pressure. Typically, due to cost, the glass articles are re-sterilized and reused.

In the last decade, the use of plastics for aseptic applications has greatly increased due to the development of sophisticated polymers and inexpensive molding techniques. Specific procedures used to pre-sterilize plastic ware include ethylene oxide (EtO) gas treatment as well as gamma irradiation. Plastics are generally cheap enough to be used once and then discarded. Other than cost, the “disposable” aspect of plastic is considered an aseptic advantage over glass by eliminating the risk associated with improperly administered and time-consuming autoclaving techniques.

### SUMMARY OF THE INVENTION

This invention improves the speed, efficiency and robustness of sterile fluid transfer in an aseptic environment. In broad terms, a peristaltic pump based dispenser is mated to a prepackaged and sterilized plastic consumable, enabling the transfer of sterile fluids in a fast, aseptic manner. In combination, the system greatly reduces the time and effort required to perform everyday transfers of aseptic fluids in many applications, including cell culture.

A distinct advantage of using a peristaltic pump compared to conventional “pipette” techniques is that the transfer of fluid from a source reservoir to a destination reservoir can be accomplished in a single step, bypassing the aspirate-move-dispense steps required of conventional hand-held pipette techniques. In addition to fewer steps, the speed of fluid transfer associated with each step can be much faster; as high as 20 ml/sec with reasonably sized tubing, as compared to ˜5 ml/sec with traditional pipettes. The operator can avoid the common complaint with conventional pipetting of arm and hand strain associated with maintaining the pipette above the work surface for extended periods of time.

### BRIEF DESCRIPTION OF THE DRAWINGS

FIG. 1 is a drawing which illustrates a prior-art pipetting technique, involving the steps of aspiration, movement and dispensing;

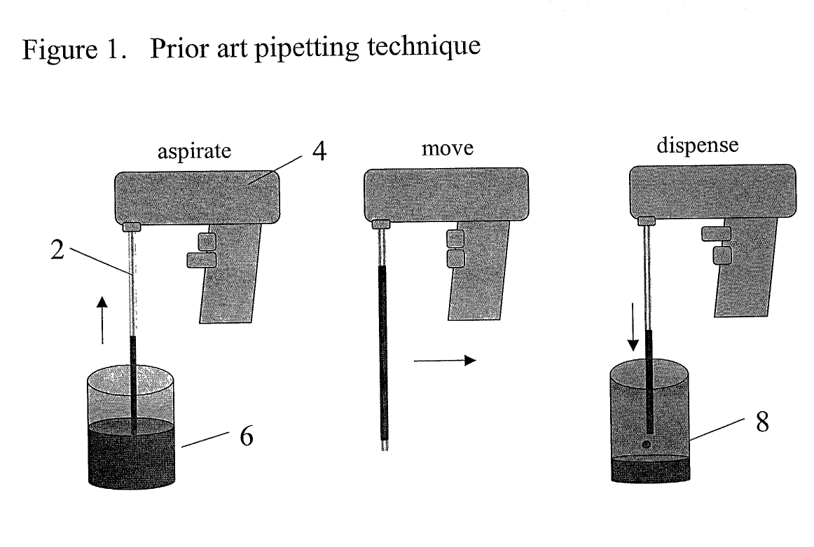

FIG. 2 is a drawing which shows the action of a peristaltic pump;

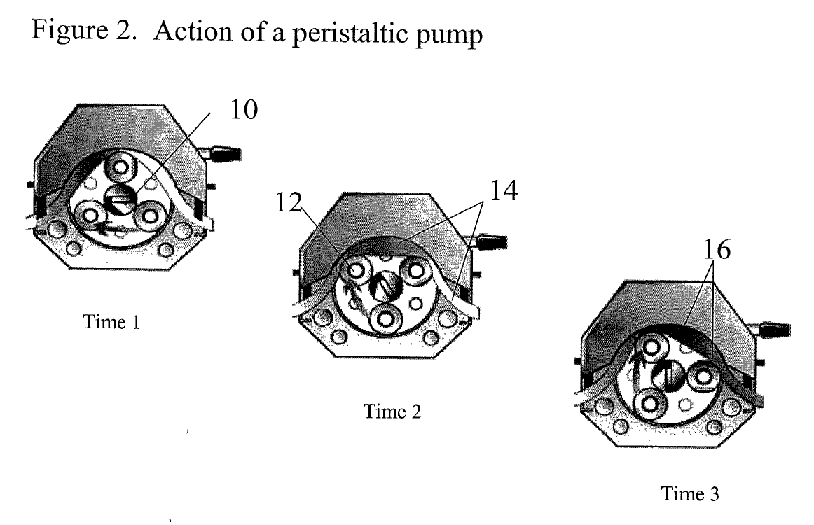

FIG. 3 is a drawing of a prefabricated consumable according to the invention; and

FIG. 4 is a drawing which shows the prefabricated consumable of FIG. 3 in use with a peristaltic pump for efficient aseptic fluid transfer.

### DETAILED DESCRIPTION OF THE INVENTION

As discussed above, this invention combines peristaltic pumping techniques with a separate fluid transfer module to facilitate the movement of sterile liquids in a fast, aseptic manner. In the preferred embodiment, the fluid transfer module takes the form of a relatively inexpensive, pre-packaged, sterilized, plastic consumable which can be easily changed and discarded as required.

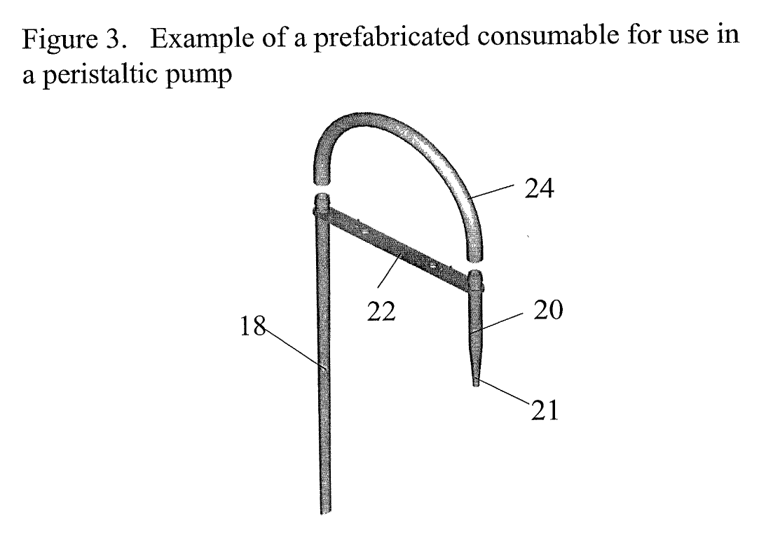

FIG. 3 depicts the preferred embodiment of such a consumable. The assembly includes an injection-molded plastic piece that contains two tubes; an input spout 18 and an output spout 20 that are joined by a cross-brace 22. The spouts are constructed of a sterilizeable plastic such as polystyrene. The consumable is pre-sterilized and packaged using EtO, Gamma irradiation, or other suitable techniques.

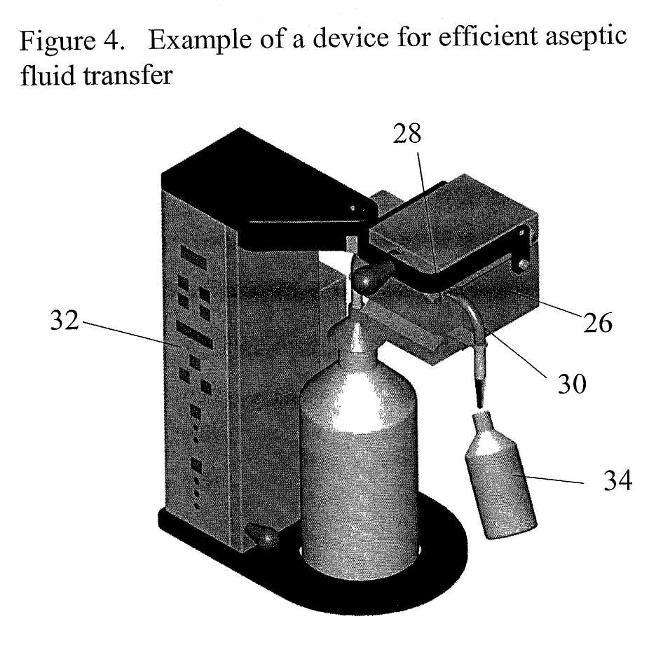

The output spout 20 preferably includes a diameter-reducing nozzle 21, and the input spout 18 is preferably longer than the output spout to enable bottles to be placed under and removed with relative ease, as best seen in FIG. 4. In order to provide a fluid path the spouts are joined by a flexible piece of pre-sterilized tubing 24. The tubing is of the type which provides an acceptable interface to the peristaltic pump rollers, allowing for fluid flow.

FIG. 4 is a drawing which shows the use of the consumable of FIG. 3 in a stand-alone dispenser according to the invention. The dispenser includes a peristaltic pump head 26 and tube clamp arrangement 28 which accept the consumable 30. The unit is user-configurable through a front panel 32, or an electronic data interface may be provided facilitating remote computerized operation of the controller. The controller may be reconfigured for left- or right-hand operation.

The front panel allows for the configuration of dispense volumes, speed and modes as well as dispense activation. The pump head 26, clamp 28, and controls may be of conventional design, though the components are configured as shown to enable the consumable to snap into place for use with conventional fluid reservoirs or bottles.

The unit is small enough to fit into a standard biological safety cabinet such that the reservoir or bottles can be openly accessed by the input or output spout. The output bottle 34 can be placed on a platform or handheld. Initiation of a dispense cycle is activated by a front panel switch, hand-touch switch, or foot switch. Other modes of operation are preferably accommodated, including “purge,” which reverses the normal direction of fluid flow, and “mix,” which cycles a specified volume of fluid for a fixed number of repetitions.

I claim:

1. A consumable adapted for use with a peristaltic pump for transferring an aseptic fluid, comprising:
a length of pre-sterilized flexible tubing having an inlet end and an outlet end, the tubing being configured for insertion into the peristaltic pump, thereby enabling an aseptic fluid to be pumped through the tubing.

2. The consumable of claim 1, further including an input spout and an output spout joined to respective ends of the flexible tubing.

3. The consumable of claim 2, wherein the spouts are plastic.

4. The consumable of claim 3, wherein the plastic is polystyrene.

5. The consumable of claim 1, wherein at least the consumable is compact enough to fit inside a standard biological safety cabinet.

6. The consumable of claim 1, wherein the consumable is pre-sterilized and packaged using EtO, Gamma irradiation, or other suitable techniques.

7. A system for transferring aseptic fluids, comprising:
a peristaltic pump; and
a pre-sterilized consumable including a length of flexible tubing having an inlet and an outlet end, the tubing being configured for insertion into the peristaltic pump, thereby enabling an aseptic fluid to be pumped through the tubing.

8. The system of claim 7, further including a controller coupled to the pump enabling a user to vary fluid volume and speed of transfer.

9. The system of claim 7, wherein the operations further including dispense, purge or mix functions.

10. The system of claim 7, wherein the controller is activated by a manual switch, front panel or foot switch.

11. The system of claim 7, wherein the controller may be reconfigured for left- or right-hand operation.

12. The system of claim 9, further including an electronic data interface facilitating remote operation of the controller.
